(19) United States
(12) Patent Application Publication
(10) Pub. No.: US 2011/0214076 A1
(43) Pub. Date: Sep. 1, 2011

(54) METHOD AND APPARATUS FOR OPTIMIZING GENERATION OF USER INTERFACE

(75) Inventors: Jie Cui, Beijing (CN); Xiao Xi Liu, Beijing (CN); Bin Wang, Beijing (CN); Jing Min Xu, Beijing (CN)

(73) Assignee: INTERNATIONAL BUSINESS MACHINES CORPORATION, Armonk, NY (US)

(21) Appl. No.: 13/034,898

(22) Filed: Feb. 25, 2011

(30) Foreign Application Priority Data
Feb. 26, 2010 (CN) 201010121992.5

(51) Int. Cl. G06F 3/048

(52) U.S. Cl. 715/762

(57) ABSTRACT

An apparatus and method which enable re-developers to perform complicated user interface development in a simple manner by setting extensible elements and loading thereto add-on application programs. In the apparatus and method of the invention, one or more extensible elements are set in a host user interface application. Then, one or more add-on user interface applications are loaded to one or more of the set extensible elements. The apparatus and method according to the invention can adjust the user interface dynamically, in real-time and finely without the need to close and reboot the application program. The apparatus and method of the invention do not limit the development language

### CROSS-REFERENCE TO RELATED APPLICATIONS

This application claims priority under 35 U.S.C. §119 to Chinese Patent Application No. 201010121992.5 filed Feb. 26, 2010, the entire contents of which are incorporated herein by reference.

### BACKGROUND OF THE INVENTION

1. Field of the Invention

The present invention relates to the computer field, and more particularly to a method and apparatus for optimizing generation of a user interface, and a method of providing a customized user interface.

2. Description of the Related Art

At present, most of the application programs running in a network environment each include a user interface. A transparent, intuitive, convenient and friendly user interface will greatly promote user's favor to an application program. Therefore, design and implementation of the user interface has become important stage in the development of a network application program.

Generally, a network application with a user interface must undergo a plurality of complicated and lengthy stages such as design, implementation, testing and adjustment before it is released. Testing and adjustment after the development of the user interface particularly consume resources. For example, in the testing and adjustment stage, testers or a few users shall be called in to test the user interface, and source codes of the user interface application are modified according to test feedback. However, many unexpected factors such as uncertainty and diversity of user requirements, some defects introduced during the development, or the occurrence of new technologies, cause developers to repeatedly adjust a user interface or even re-develop it after the release of the network application with the user interface.

As an example, as shown in FIG. 7, in a typical user login interface, an original user interface 700 requires a user to input a complete email address. However, in an amended user interface 701, all email addresses of the user are displayed by double clicking an email address input field, or an icon 702 is added adjacent to the email address input field, and then a dialog indicating further how to input is displayed by clicking the icon.

In cases where there is a need to adjust or re-develop a user interface, developers can modify the source codes of the user interface and repeat the above testing and adjustment many times. Modifying the source codes many times is not only troublesome and fallible but also results in extra costs for managing a plurality of modified versions of the user interface. Furthermore, in a general case, modifying the source codes of the user interface will require the user to reboot the application program to render the amended user interface, so the user interface cannot be adjusted in real-time and dynamical manner.

Although existing Portal and Mashup technologies in the network field can combine and replace some of element blocks of a user interface to a limited extent, the two technologies can only realize coarse-grained adjustment of the user interface. The Portal and Mashup technologies can only realize adjustment in a level of page blocks but cannot realize fine-grained adjustment in a level of user interface elements.

A system capable of supporting customized user experience to an application program is described in U.S. Patent Publication No. 20090327912 entitled, “Customization of Client-Server Interaction in an Internet Application.” The application discloses systems and methods for customization of internet applications and their associated user interfaces in a browser based environment. The user interfaces are typically delivered to a user as a web page. The customization applies to both static and functional aspects of user interface elements. Functional properties of a user interface element include operations beyond basic point and click navigation and retrieval of further content using a URL. For example, a user is able to control methods of data input and output, the presentation of requested information, logical operations, or characteristics of communication between the browser compatible interface and servers. Configuration and personalization can be applied to individual user interface elements, individual user interfaces and associated web pages, all internet application user interfaces accessed by a user, or groups of user interfaces within a specific internet application. However, the system provides user interfaces configured in advance instead of dynamically adjusting a specific user interface.

A system capable of supporting customized user experience to an application program is described in U.S. Patent Publication No. 20060242124, entitled “System for Defining and Activating Pluggable User Interface Components for a Deployed Application.” In the system, several user interfaces are configured in advance by taking factors such as client software, browser version number, operating system platform into consideration. The system can identify an access mode (e.g. personal computer or mobile phone) by which the user accesses to an application program server, thereby rendering different user interfaces configured in advance according to the identified access mode of the user. However, the system provides user interfaces configured in advance instead of dynamically adjusting a specific user interface.

There is a need for an apparatus and method capable of dynamically and finely optimizing generation of a user interface to facilitate re-development of the user interface, such that developers can perform re-development of the user interface in a simple manner on the basis of the initially developed user interface.

### SUMMARY OF THE INVENTION

An object of the invention is to enable the developers to perform re-development of the user interface in a simple manner, on the basis of the work of the initial developers. The re-developers for the re-development can be the same as the initial developers or not.

According to an aspect of the invention, provided is an apparatus for optimizing generation of a user interface. The optimization apparatus includes an extensible element setter configured to set a set of extensible elements in a host user interface application corresponding to the user interface, and a loader configured to load add-on user interface applications for respective extensible elements in the set of extensible elements, to adjust corresponding user interface elements of the user interface.

According to another aspect of the invention, provided is a method for optimizing generation of a user interface. Optimization includes setting a set of extensible elements in a host user interface application corresponding to the user interface, and loading add-on user interface applications for respective extensible elements in the set of extensible elements, to adjust corresponding user interface elements of the user interface.

According to a further aspect of the invention, provided is a method for assisting in development of a user interface The method includes presenting the user interface on which a set of extensible elements is set, and in response to a request to attach add-on user interface applications to one or more extensible elements in the set of extensible elements, attaching the add-on user interface applications to the one or more extensible elements in the set of extensible elements.

According to an aspect of the invention, provided is an apparatus for assisting in development of a user interface, comprising: means for presenting the user interface on which a set of extensible elements is set; and means for, in response to a request to attach add-on user interface applications to one or more extensible elements in the set of extensible elements, attaching the add-on user interface applications to the one or more extensible elements in the set of extensible elements.

According to an aspect of the invention, provided is a method of providing a user interface, comprising: presenting a user interface with a set of extensible elements; inquiring a terminal user about whether or not attaching add-on user interface applications is desirable, for one or more extensible elements in the set of extensible elements on the user interface; and in response to a response from the terminal user that attaching add-on user interface applications is desirable, loading the add-on user interface applications to the extensible elements.

As compared with the existing user interface design and implementation solution, an advantage of the apparatus and method according to an aspect of the present invention is that it can realize re-development of the user interface on the basis of the work of the initial developers in a simple manner, in the future adjustment to the user interface, once such extensible elements are set in the user interface. Moreover, since in general, the user interface elements are basic units of the user interface, the user interface adjusting apparatus and method of the invention can realize fine adjustment to the user interface, thereby enhancing user experience in detail.

An additional advantage, according to yet a further aspect of the invention, when the application program runs and proceeds to an extensible element of the user interface, presentation of the add-on user interface application will be activated according to the user's operation or automatically. Therefore, the modifications to the user interface can be rendered dynamically and in real-time without the need to close and then reboot the application program.

A further advantage of the apparatus and method according to an embodiment of the invention, is that a more free and broad selection can be made to the add-on user interface, to provide more powerful development support for the user interface developers. For example, the programming language for the add-on user interface application is not limited, and it can be the same with the programming language of the host user interface application or not; the add-on user interface application can be locally or remotely deployed, or the like.

Other characteristics and advantages of the invention will become obvious in combination with the description of accompanying drawings, wherein the same number represents the same or similar parts in all figures.

### BRIEF DESCRIPTION OF THE DRAWINGS

FIG. 1 is a schematic diagram illustrating a user interface design system according to an embodiment of the invention;

FIG. 2 is a schematic diagram illustrating a user interface design system according to another embodiment of the invention;

FIGS. 3A-3D illustrate exemplary user interface adjustment obtained by a user interface design system according to an embodiment of the invention;

FIG. 4 is a flow chart illustrating a user interface design method according to an embodiment of the invention;

FIG. 5 is a flow chart illustrating a process of setting extensible elements in a user interface according to an embodiment of the invention;

FIG. 6 is a flow chart illustrating a process of designing or selecting an add-on user interface application according to an embodiment of the invention; and

FIG. 7 illustrates an example of user interface adjustment according to an embodiment of the invention.

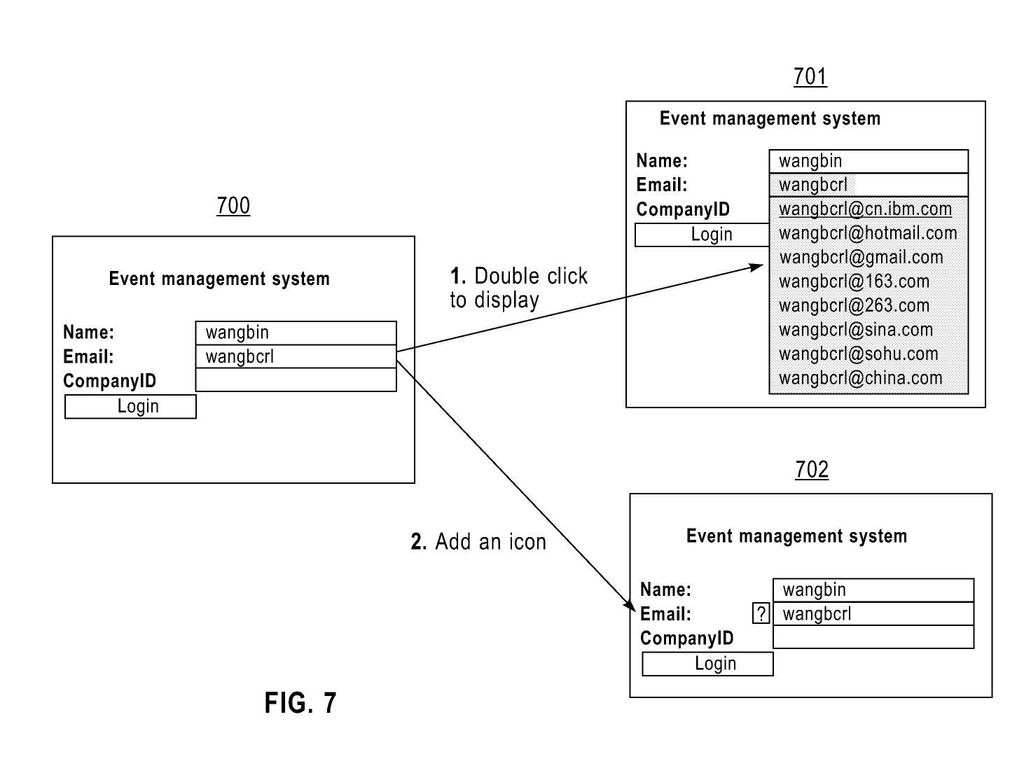

### DETAILED DESCRIPTION OF THE PREFERRED EMBODIMENTS

It should be appreciated that, the accompanying drawings and the description of the invention have been simplified to exemplify those steps or components helpful for the clear understanding of the invention. Also for sake of clarity, other steps or components that are typical in the application program design and implementation. Those skilled in the art would appreciate that, in order to carry out the invention, other steps or components are desirable and/or necessary. However, since the steps or components are well known in the art and they are not helpful for better understanding the invention, they are not described in the specification. It should be further appreciated that, the accompanying drawings involved in the specification only show graphical expressions of the current exemplary embodiments of the invention, and the steps or components falling into the scope of protection of the invention can include steps or components different from those shown in the accompanying drawings. The embodiments of the invention are described below with reference to the accompanying drawings, wherein like steps or components are denoted by like reference signs.

The apparatus and method of the invention set extensible elements in the user interface. The extensible elements are embodied as logics at set locations in a user interface application corresponding to the user interface. When the user interface application runs and proceeds to the logic, it is judged if there is an add-on application program or other logic attached to the extensible element. If an add-on application program or other logic is attached, the add-on application program or other logic is executed. If there are no attached add-on application programs or other logic, no actions are executed. These extensible elements set in the user interface application are like small “hooks,” and re-developers or initial developers could attach desired add-on application programs or other logics to any one of “hooks,” or replace or remove the attached add-on application programs or other logics, at any time as needed.

If the initial developers had developed a user interface application but did not leave several points for judging if there is an add-on application program or other logic attached thereto, the re-developers could not attach desired add-on application programs or other logics in the user interface application. In an aspect of the invention, since the initial developers had left several points (i.e. extensible elements) for judging if there is an add-on application program or other logic attached thereto, the re-developers can flexibly attach thereto desired add-on application programs or other logics, thereby re-develop the user interface in a simple manner.

As described above, the apparatus and method according to an embodiment of the invention are implemented by setting extensible elements in a user interface application and loading one or more add-on application programs at the extensible elements. As used herein, the term “extensible elements” refer to those user interface elements that are set in the user interface and can be attached with add-on application programs, and are specifically embodied as a segment of logics for judging if there is an add-on application program or other logic attached thereto. As also described above, the extensible elements are like small “hooks”, and the developers could attach desired add-on application programs or other logics to the extensible elements, or replace or remove the attached add-on application programs or other logics, at any time as needed. This optimizes generation of the user interface and facilitates the re-developers to develop a final user interface.

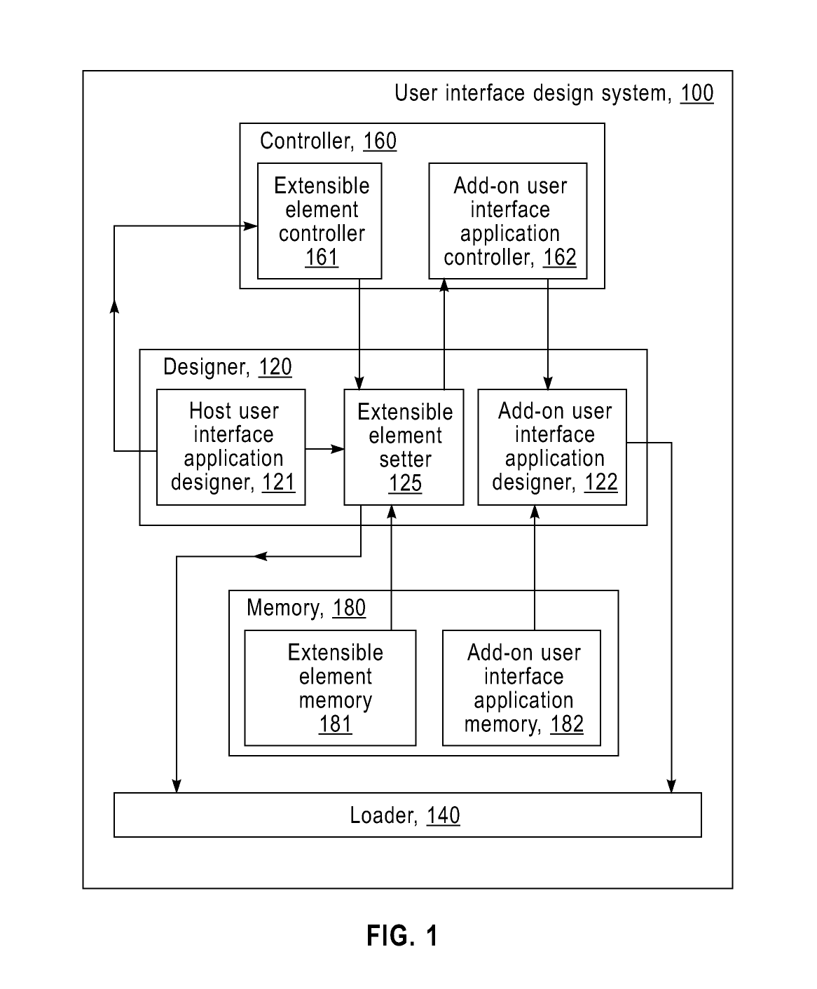

A user interface design system capable of implementing an aspect of the invention is described below in detail. FIG. 1 is a schematic diagram illustrating a user interface design system 100 according to an embodiment of the invention. The user interface design system 100 as shown in FIG. 1 includes a designer 120, a loader 140, a controller 160 and a memory 180. The components of the system are described below in detail.

The designer 120 is configured to cooperate with the controller 160 and the memory 180 to provide a host user interface application set with extensible elements and add-on user interface applications (and other logics, which are described in detail below) to be attached to the set extensible elements. The designer 120 shown in FIG. 1 includes a host user interface application designer 121, an add-on user interface application designer 122 and an extensible element setter 125.

The host user interface application designer 121 is used for designing and implementing a host user interface application program, and the add-on user interface application designer 122 is used for designing and implementing add-on user interface application programs. The host user interface application designer 121 and the add-on user interface application designer 122 can include various kinds of common tools or components required for designing and implementing the user interface. The host user interface application designer 121 and the add-on user interface application designer 122 are collectively referred as user interface application designer. In order not to deviate from description of substantive contents of the invention, the common tools or components are not shown in FIG. 1, and descriptions thereof are thus omitted here.

The host user interface application designed and implemented in the host user interface application designer 121 can be loaded into the extensible element setter 125. The extensible element setter 125 is used for setting extensible elements for the loaded host user interface application, e.g. for attaching other user interface programs to the loaded host user interface application. The extensible element can but not necessarily be attached with an add-on user interface application or other logic. Whether or not to be attached can be decided by the re-developers. Of course, the re-developments possibly are the initial developers. The user interface design system of the invention supports various types of extensible elements and covers various commonly-used user interface elements, e.g. InputText with an extensible interface, OutputText, ActionButton, InputTextArea, DataTable, ActionLink, Selector, Calendar, ActionImage and so on.

The host user interface application and the add-on user interface application generally use the same developing language. According to an embodiment of the invention, the host user interface application and the add-on user interface application can use different developing languages, because the host user interface application and add-on user interface application can be attached to each other through the extensible elements set by the extensible element setter 125, instead of being directly programmed together. When the host user interface application program runs and proceeds to the extensible elements, a client browser will present an add-on user interface program attached to the extensible elements according to the set user actions or in accordance with a programming logic via a host application program server or an agent server. Therefore, when the user interface is adjusted dynamically by using the technology of the invention, it is unnecessary that the host user interface application and the add-on user interface application use the same developing language, thereby providing more design flexibility and convenience for developers.

It should be noted that, although both the host user interface application designer 121 and the add-on user interface application designer 122 are shown in the user interface design system of FIG. 1, the two designers are not necessarily required at the same time when implementing the dynamic adjustment technology of the invention. In another embodiment of the invention, the host user interface application designer 121 can be omitted. In this case, the user can load the developed user interface program into the user interface design system 100 of the invention, and directly set extensible elements in the extensible element setter 125. In case where there exists an add-on user interface application and only one type is available, the add-on user interface application designer 122 can be omitted and the existing add-on user interface application is directly loaded by the loader 140 to be described below.

In another embodiment of the invention, the user interface design system 100 is further provided with the memory 180 for storing various kinds of data during the user interface design, e.g. various types of extensible elements, add-on user interface applications, history record information or the like. As shown in FIG. 1, the memory 180 can include an extensible element memory 181 and an add-on user interface application memory 182.

The extensible element memory 181 is used for storing various types of extensible elements with extensible interfaces, including but not limited to the above-mentioned commonly-used user interface elements, such as InputText, OutputText, ActionButton, InputTextArea, DataTable, ActionLink, Selector, Calendar, ActionImage or the like. The developers can invoke one or more extensible elements stored in the extensible element memory 181 by the extensible element setter 125 and set the invoked extensible elements to any location of the host user interface application (program) provided by the host user interface application designer 121.

The add-on user interface application memory 182 is used for storing add-on user interface application programs or network addresses thereof. As described above, in the embodiments of the invention, the user can design and implement the desired add-on user interface applications in the add-on user interface application designer 122. In an embodiment of including the add-on user interface application memory 182, the user can also directly invoke add-on user interface application programs stored in the add-on user interface application memory 182. It should be noted that, the add-on user interface application memory 182 can store local add-on user interface application programs, or network addresses of remote add-on user interface application programs such as uniform resource locator (URL), from which the remote add-on user interface application programs can be acquired. As well known by those skilled in the art, the examples of the add-on user interface application programs include for example Popup Dialog, Show Div, Add link, Attach link, Show Frame, Add Button, Attach Button, Show Widget, Add Image, and so on.

All or designated types of extensible elements in the host user interface application, or all extensible elements available to the user, stored in the extensible element memory 181 can be presented to the user for selection of one or more thereof. The add-on user interface applications available to the user stored in the add-on user interface application memory 182 can be presented to the user for selection.

Furthermore, in another embodiment of the invention, the user interface design system 100 is further provided with a controller 160, as shown in FIG. 1. The controller 160 shown in FIG. 1 can include an extensible element controller 161 and an add-on user interface application controller 162. The extensible element controller 161 is configured to scan the whole user interface program provided by the host user interface application designer 121 to list all the extensible elements existing in the user interface program.

After the re-developers obtain (e.g. purchase) from the initial developers the user interface application with “extensible elements,” they in fact also obtain the user interface design system 100 shown in FIG. 1, as a tool associated with the user interface application. Therefore, after the re-developers load the user interface application with the “extensible elements” in a general-purpose computer, the user interface with a set of extensible elements are displayed on the general-purpose computer. At this time, in response to a request from the re-developers to attach an add-on user interface application to a selected extensible element among the set of extensible elements, the extensible element controller 161 receives a selection to the extensible element by the re-developers, and the add-on user interface application controller 162 attaches the add-on user interface application to the selected extensible element among the set of extensible elements in the user interface.

When the initial developers set extensible elements at some points in the host user interface application, a segment of logic for judging if there is an add-on user interface application or other application attached thereto is placed in each of the points. That is to say, the initial developers place a segment of logic at points where the extensible elements are set and there are some unfilled items in the logic. When the re-developers fill in the items, a result of executing the segment of logic directs to the desired add-on user interface application or other application. This refers to “attachment”. In the web page, the re-developers only need to move some icons, i.e. moving the icons to specified locations, which achieve the effect of filling in unfilled items in the segment of logic.

In response to a request to attach a logic for inquiring a terminal user about if attaching the add-on user interface applications to the extensible elements in the set of extensible elements is desirable while attaching the add-on user interface applications to the extensible elements, the extensible element controller 161 receives a selection to the extensible element by the re-developers, and the add-on user interface application controller 162 attaches a logic for inquiring a terminal user about if attaching the add-on user interface applications to the extensible elements in the set of extensible elements is desirable while attaching the add-on user interface applications to the extensible elements. After the re-developers attaches a logic for inquiring a terminal user about if attaching the add-on user interface applications to the extensible elements in the set of extensible elements is desirable while attaching the add-on user interface applications to the extensible elements through the add-on user interface application controller 162, once the re-developed user interface application is loaded by a service provider, the server of the service provider presents to the terminal user the user interface with the extensible elements, and with respect to the extensible elements in the set of extensible elements in the user interface, inquires the terminal user about if attaching the add-on user interface applications to the extensible elements is desirable. In response to a response from the terminal user that attaching the add-on user interface applications to the extensible elements is undesirable, the loader 140 (since the re-developed user interface application is loaded into the server of the service provider, the user interface design system 100 is also loaded into the server) does not load the add-on user interface application to the extensible elements. In response to a response from the terminal user that attaching the add-on user interface applications to the extensible elements is desirable, the loader 140 loads the add-on user interface application to the extensible elements.

In response to a request to attach a logic for inquiring a terminal user about which add-on user interface application among a plurality of add-on user interface applications is to be attached to the extensible elements in the set of extensible elements while attaching the plurality of add-on user interface applications to the extensible elements, the extensible element controller 161 receives a selection to the extensible elements by the re-developers, and the add-on user interface application controller 162 attaches a logic for inquiring the terminal user about which add-on user interface application is to be attached to one or more extensible elements in the set of extensible elements while attaching the plurality of add-on user interface applications to the extensible elements. After the re-developers attaches a logic for inquiring the terminal user about which add-on user interface application among the plurality of add-on user interface applications is to be attached to the extensible elements in the set of extensible elements while attaching the plurality of add-on user interface applications to the extensible elements through the add-on user interface application controller 162, once the re-developed user interface application is loaded by a service provider, the server of the service provider presents to the terminal user the user interface with the extensible elements, and with respect to the extensible elements in the set of extensible elements in the user interface, inquires the terminal user about which add-on user interface application is to be attached to the extensible elements. In response to the selection to the add-on user interface by the terminal user, the loader 140 loads the selected add-on user interface application to the extensible elements.

In an alternative embodiment of the invention, the extensible element controller 161 can cooperate with the extensible element memory 181 to control the extensible elements available to the developers in the extensible element setter 125, for example, presenting various extensible element available to the user, such that the user can add extensible elements to the host user interface application provided by the host user interface application designer 121. This facilitates design and implementation of the user interface embedded with extensible elements.

Although the extensible element setter 125 and the extensible element controller 161 shown in the figure are separate from each other, those skilled in the art would appreciate that, in the embodiment for implementing the invention, a single component combining the functions of the two can be used for implementing the functions thereof.

The add-on user interface application controller 162 in the controller 160 can cooperate with the add-on user interface application memory 182, the extensible element setter 125 and the host user interface application designer 121, to provide the developers with add-on user interface applications designed in the add-on user interface application designer 122 for information on the extensible elements set in the extensible element setter 125 and the host user interface application provided by the host user interface application designer 121 (e.g. the type of the set extensible elements or a scenario of the host user interface), for example, presenting various add-on user interface applications available to the user, thereby facilitating design and selection of the add-on user interface applications by the user.

The user interface design system 100 provides to the loader 140, the extensible elements in the user interface set by the extensible element setter 125 and the desired add-on user interface applications designed or selected in the add-on user interface application designer 122, as shown in FIG. 1. The loader 140 is used for loading the designed or selected add-on user interface applications to the set extensible elements, to realize dynamic adjustment of the user interface.

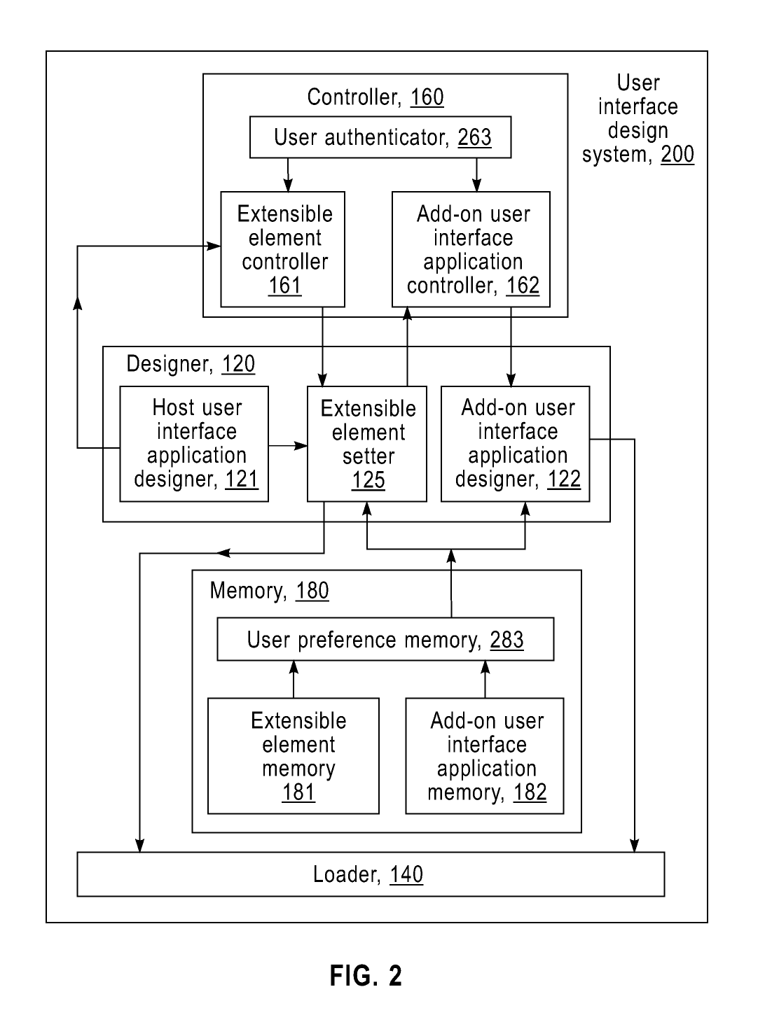

FIG. 2 is a schematic diagram illustrating a user interface design system 200 according to another embodiment of the invention. The user interface design system 200 in FIG. 2 is substantively the same as the user interface design system 100 in FIG. 1. The user interface design system 200 in FIG. 2 differs from the user interface design system 100 in FIG. 1 in that, the memory 180 is further provided with a user preference memory 283 and the controller 160 is provided with a user authenticator 263. The same reference signs are used in the user interface design system 200 to represent the same parts in the user interface design system 100. The user preference memory 283 and the user authenticator 263 in the user interface design system 200 are described below in detail, and descriptions of the same parts as the user interface design system 100 are omitted.

The user preference memory 283 is configured to record extensible elements of the type preferred by the user and add-on user interface applications preferred by the user. In this way, the extensible element setter 125 can set extensible elements by referring to the preferred extensible elements stored in the user preference memory 283. Likewise, the loader can load add-on user interface applications according to preference records stored in the user preference memory 283.

The user preference memory 283 can record, for example, history information regarding the user's selection. According to statistical results of the history information during a predetermined period of time, the extensible elements preferred by the user and/or the add-on user interface applications preferred by the user can be obtained and recorded in the user preference memory 283. That is, the records in the user preference memory can be obtained statistically based on the extensible elements and the add-on user interface applications selected by the user during a predetermined period of time. Furthermore, the records stored in the user preference memory 283 can also be predefined by the user through an input mechanism, for example. Of course, those skilled in the art would appreciate that the user preference memory 283 can use many other approaches to provide user preference information.

The user authenticator 263 in the controller 160 is used for authenticating the user. The controller 160 presents extensible elements for the user to select based on an authentication result of the user authenticator, and presents add-on user interface applications for the user to select based on the authentication result of the user authenticator. Specifically, the user authenticator 263 is configured to authenticate the user identity and thereby identify the user's right. The user authenticator 263 can authenticate the user by requiring the user to input an identifier and password, or by means of, for example, fingerprint, iris input or the like. The user authenticator 263 provides the authentication result to the extensible element controller 161 and the add-on user interface application controller 162. The extensible element controller 161 can control the extensible elements available to the user based on the authentication result of the user authenticator 263 and the identified user's right. Likewise, the add-on user interface application controller 162 can control the add-on user interface applications available to the user based on the authentication result of the user authenticator 263 and the identified user's right.

It should be appreciated that, although for sake of clarity and completeness, the above-shown embodiments of the invention include components such as controller, memory, host/add-on user interface application designer, some of the components are unnecessary to practice the user interface dynamic adjustment technology of the invention. Those skilled in the art could omit one or more of the components as needed, or add one or more commonly-used user interface design components to the design system.

The invention can be practiced by setting one or more extensible elements in the extensible element setter 125 and loading one or more add-on application programs in the loader 140 to the set extensible elements.

Here, the extensible element setter 125 and the loader 140 are collectively referred as an apparatus for optimizing generation of the user interface.

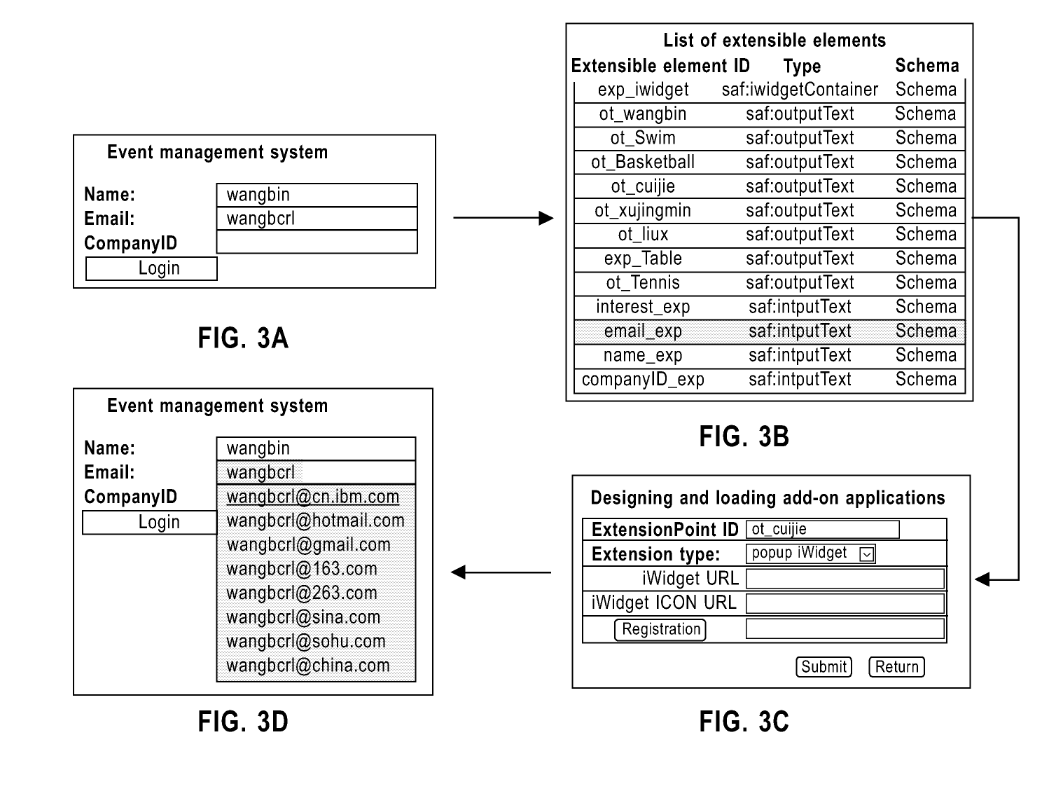

FIGS. 3A-3D show exemplary user interface adjustment obtained by a user interface design system (e.g. the user interface design system 100 in FIG. 1 or the user interface design system 200 in FIG. 2) according to an embodiment of the invention.

FIG. 3A illustratively shows a user interface for user login, which requires the user to input a complete email address. According to an embodiment of the invention, the user interface application corresponding to the user interface is loaded into the user interface design system of the invention, e.g. the user interface design system 100 in FIG. 1. All the extensible elements existing in the user interface are presented under the control of the extensible element controller 161, as the “list of extensible elements” shown in FIG. 3B does. The extensible element setter 125 sets one of the extensible elements, e.g. the extensible element item “email_exp” that is highlighted in the column of extensible element ID in the “list of extensible elements” in FIG. 3B. Subsequently, as shown in FIG. 3C, an add-on application program, e.g. “Popup Widget” is selected for the set extensible element “email_exp”. After the selected add-on application program is submitted and loaded, the amended user interface is rendered, as shown in FIG. 3D, and a plurality of email addresses of the user can be displayed through a “Popup Widget”.

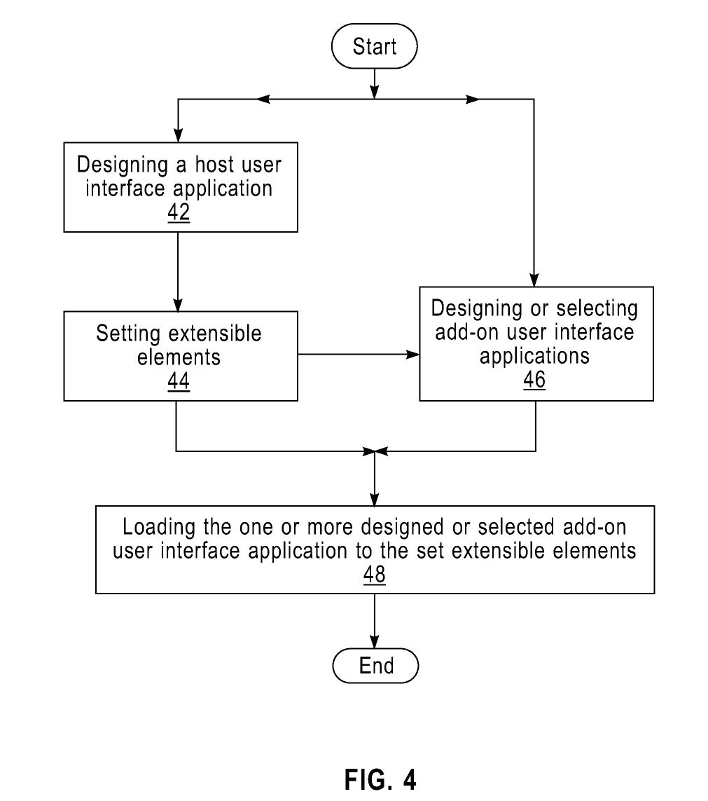

FIG. 4 is a flow chart showing an overall process of a user interface design method according to an embodiment of the invention. The process includes a step 42 of designing a host user interface application; a step 44 of setting extensible elements in the host user interface; a step 46 of designing or selecting add-on user interface applications for the set extensible elements; and a step 48 of loading the add-on user interface applications designed or selected in the step 46 to the extensible elements set in the step 44.

The user interface design process is also a user interface adjustment process. Those skilled in the art would appreciate that, the developed host user interface application can be adjusted while dynamically adjusting the user interface, so the step 42 of designing a host user interface application can be omitted; likewise, the step 46 of designing or selecting an add-on user interface application can also be omitted, and the existing add-on user interface application is directly loaded in the loading step 48, e.g. a pre-specified window is pop up.

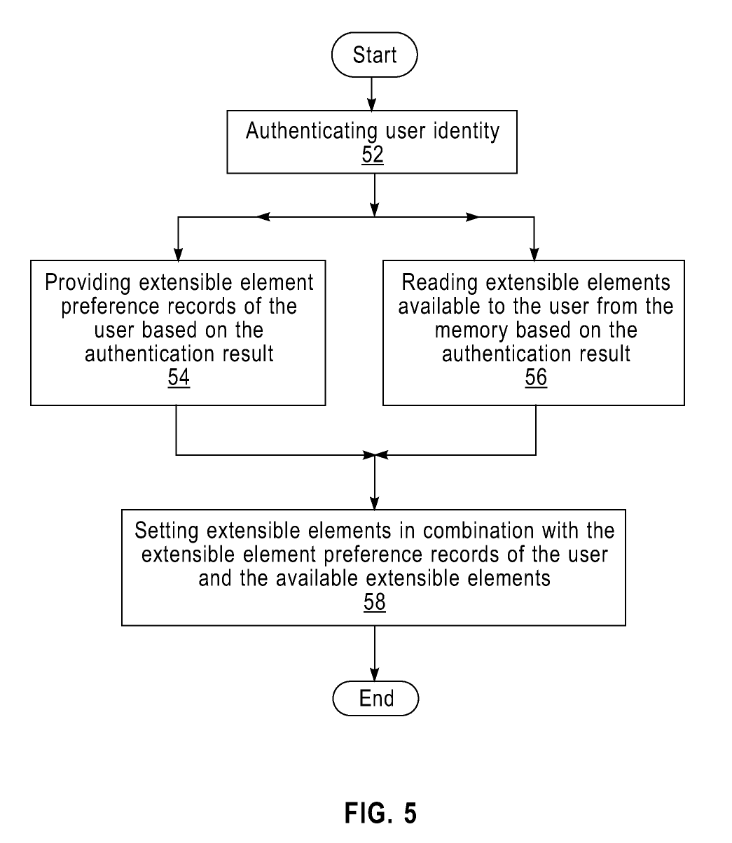

FIG. 5 is a flow chart specifically showing the step 44 of setting extensible elements in FIG. 4 according to an embodiment of the invention. At step 52, user identity is authenticated to determine an access right of the user. At step 54, the extensible element preference records of the user are provided by accessing the memory of the user interface design system, using the authentication result. At step 56, extensible elements available to the user are read from the memory based on the user right authenticated in the step 52. Of course, those skilled in the art would appreciate that, the authenticating step 52, the preference record providing step 54 and the available extensible element providing step 56 are not necessary, and the user interface design method according to another embodiment of the invention is capable of providing all the available extensible elements in the memory without authenticating user identity. The process advances to a step 58 where one or more extensible elements to be processed are selected in combination with the user preference records provided in the step 54 and the available extensible elements provided in the step 56.

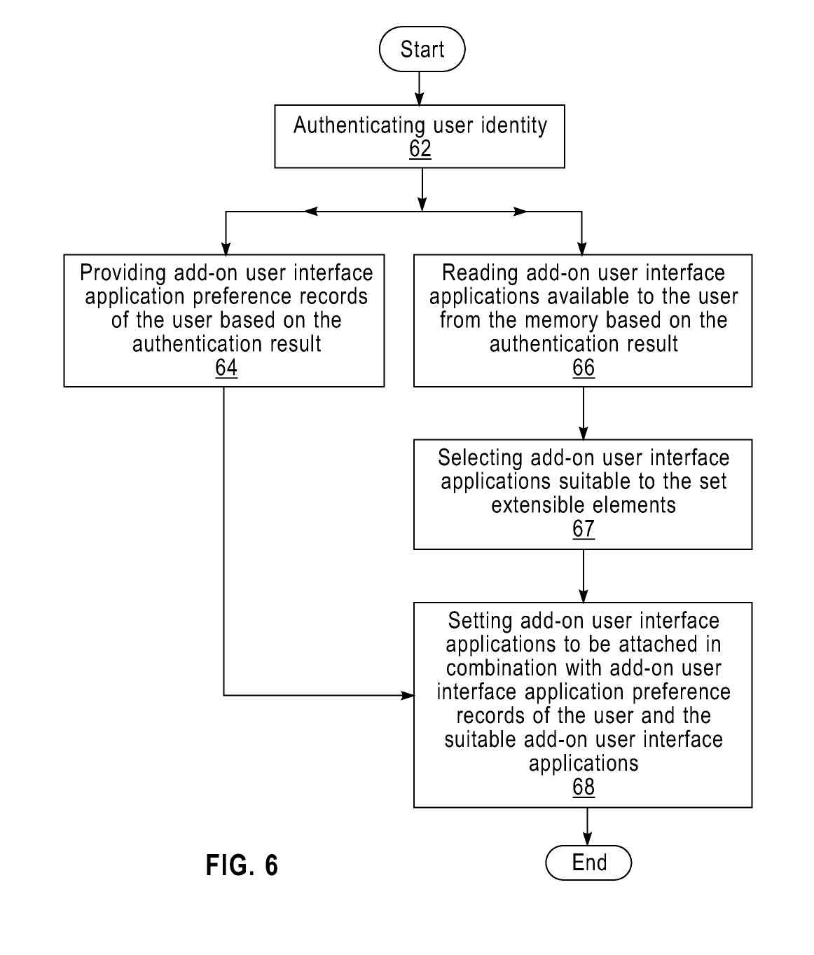

FIG. 6 is a flow chart showing the step of designing or selecting add-on user interface applications in FIG. 4 according to an embodiment of the invention. At step 62, user identity is authenticated to determine an access right of the user. At step 64, add-on user interface application preference records of the user are provided by accessing the memory of the user interface design system, using the authentication result. At step 66, add-on user interface applications available to the user are read from the memory based on the user right authenticated in the step 62. Of course, those skilled in the art would appreciate that, the authenticating step 62, the preference record providing step 64 and the available add-on user interface application providing step 66 are not necessary, and the user interface design method according to another embodiment of the invention is capable of providing all the available add-on user interface applications in the memory without authenticating user identity.

Preferably, the steps 62, 64 and 66 in FIG. 6 can be combined with the step 52, 54 and 56 in FIG. 5. For example, after the user identity is authenticated, both of the extensible element preference records and the add-on user interface application preference records are provided based on the authentication results, and both of the extensible elements and the add-on user interface applications available to the user are read from the memory based on the authenticated user right.

The process advances to a step 67 where add-on user interface applications suitable to the extensible elements set in the step 44 of FIG. 4 are selected from the available add-on user interface applications read from the memory. Then in step 68, one or more add-on user interface applications to be attached are selected in combination with the user preference records provided in step 64 and the suitable user interface applications provided in the step 67. It should be noted that, according to another embodiment of the invention, the steps 62, 64, 66, 67, 68 can be omitted and the add-on user interface applications suitable to the set extensible elements are directly designed.

As will be appreciated by one skilled in the art, aspects of the present invention can be embodied as a system, method or computer program product. Accordingly, aspects of the present invention can take the form of an entirely hardware embodiment, an entirely software embodiment (including firmware, resident software, microcode, etc.) or an embodiment combining software and hardware aspects that can all generally be referred to herein as a “circuit,” “module” or “system.” Furthermore, aspects of the present invention can take the form of a computer program product embodied in any tangible medium of expression having computer usable program code embodied therein.

Any combination of one or more computer usable or computer readable medium(s) can be utilized. The computer usable or computer readable medium can be, for example, but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission medium supporting for example the Internet or Intranet, or a magnetic storage device. Note that the computer usable or computer readable medium even can be paper or other suitable medium on which programs are printed, and this is because the programs can be obtained electronically by electrically scanning the paper or other medium, and then be compiled, interpreted or processed appropriately, and be stored in a computer memory if necessary. In the context of this document, a computer usable or computer readable storage medium can be any medium that contains, stores, communicates, propagates, or transmits a program for use by or in connection with an instruction execution system, apparatus, or device. A computer useable medium can include a data signal with computer usable program code embodied therein, propagated in baseband or as part of a carrier wave. The computer usable program code can be transmitted using any appropriate medium, including but not limited to wireless, wireline, optical fiber cable, RF, etc.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the computer or other programmable data processing apparatus, create means for implementing the functions/acts specified in the blocks of the flowchart illustrations and/or block diagrams.

These computer program instructions can also be stored in a computer readable medium that can direct a computer or other programmable data processing apparatus to function in a particular manner, such that the instructions stored in the computer readable medium produce an article of manufacture including instruction means which implement the functions/acts specified in the blocks of the flowchart illustrations and/or block diagrams.

The computer program instructions can also be loaded onto a computer or other programmable data processing apparatus to cause a series of operational steps to be performed on the computer or other programmable data processing apparatus to produce a computer implemented process such that the instructions which execute on the computer or other programmable apparatus provide processes for implementing the functions/acts specified in the blocks of the flowchart illustrations and/or block diagrams.

The flowchart illustrations and block diagrams in the figures illustrate the architecture, functionality, and operation of possible implementations of systems, methods and computer program products according to various embodiments of the present invention. In this regard, each block in the flowchart illustrations or block diagrams can represent a module, program segment, or portion of code, which includes one or more executable instructions for implementing the specified logical function(s). It should also be noted that, in some alternative implementations, the functions noted in the blocks can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims are intended to include any structure, material, or act for performing the function in combination with other claimed elements as specifically claimed. While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadcast interpretation so as to encompass all such modifications and equivalent structures and functions.

What is claimed is:

1. An apparatus for optimizing generation of a user interface, comprising:
an extensible element setter configured to set a set of extensible elements in a host user interface application corresponding to the user interface; and
a loader configured to load add-on user interface applications for respective extensible elements in the set of extensible elements, to adjust corresponding user interface elements of the user interface.

2. The apparatus according to claim 1, further comprising:
a user interface application designer configured to design the host user interface application and add-on user interface applications.

3. The apparatus according to claim 2, wherein the user interface application designer comprises:
a host user interface application designer configured to design the host user interface application; and
an add-on user interface application designer configured to design the add-on user interface applications.

4. The apparatus according to claim 1, further comprising:
a memory configured to store all types of extensible elements and add-on user interface applications or network addresses thereof.

5. The apparatus according to claim 1, further comprising:
a controller configured to present all or designated types of extensible elements of the host user interface application or all extensible elements available to a user, to enable the user to select one or more of the presented extensible elements, and to present add-on user interface applications available to the user to enable the user to select one of more of the presented add-on user interface applications.

6. The apparatus according to claim 5, further comprising:
a user authenticator configured to authenticate a user,
wherein the controller is configured to present extensible elements for selection by the user based on an authentication result by the user authenticator and to present add-on user interface applications for selection by the user based on the authentication result by the user authenticator.

7. The apparatus according to claim 1, further comprising:
a user preference memory configured to, for each user, record extensible elements of types preferred by the user and add-on user interface applications preferred by the user,
wherein the extensible element setter is configured to set extensible element(s) by referring to the preferred extensible elements recorded in the user preference memory, and the loader is configured to load add-on user interface application(s) according to preference records stored in the user preference memory.

8. The apparatus according to claim 7, wherein the records in the user preference memory are calculated statistically based on extensible elements and add-on user interface applications selected by a user during a predetermined period of time.

9. A method for optimizing generation of a user interface, the method comprising:
setting a set of extensible elements in a host user interface application corresponding to the user interface; and
loading add-on user interface applications for respective extensible elements in the set of extensible elements, to adjust corresponding user interface elements of the user interface.

10. The method according to claim 9, further comprising:
storing all types of extensible elements and add-on user interface applications or network addresses thereof.

11. The method according to claim 10, further comprising:
presenting all or designated types of extensible elements of the host user interface application or all extensible elements available to a user, to enable the user to select one or more of the presented extensible elements, and presenting add-on user interface applications available to the user to enable the user to select one of more of the presented add-on user interface applications.

12. The method according to claim 11, further comprising:
authenticating a user,
wherein extensible elements are presented for selection by the user based on an authentication result and add-on user interface applications are presented for selection by the user based on the authentication result.

13. The method according to claim 9, further comprising:
for each user, recording extensible elements of types preferred by the user and add-on user interface applications preferred by the user,
wherein extensible element(s) is set by referring to the stored preferred extensible elements, and add-on user interface application(s) is loaded according to preference records.

14. The method according to claim 13, wherein the recorded extensible elements of types preferred by the user and add-on user interface applications preferred by the user are calculated statistically based on extensible elements and add-on user interface applications selected by a user during a predetermined period of time.

15. A method for assisting in development of a user interface, the method comprising:
presenting the user interface on which a set of extensible elements is set; and
in response to a request to attach add-on user interface applications to one or more extensible elements in the set of extensible elements, attaching the add-on user interface applications to the one or more extensible elements in the set of extensible elements.

16. The method according to claim 15, further comprising:
in response to a request to attach a logic for inquiring a terminal user about if attaching the add-on user interface applications to the extensible elements in the set of extensible elements is desirable while attaching the add-on user interface applications to the extensible elements, attaching the logic for inquiring the terminal user about if attaching the add-on user interface applications to the extensible elements in the set of extensible elements is desirable while attaching the add-on user interface application to the extensible elements.

17. The method according to claim 15, further comprising:
in response to a request to attach a logic for inquiring a terminal user about which add-on user interface application among the add-on user interface applications is to be attached to the extensible elements in the set of extensible elements while attaching the add-on user interface applications to the extensible elements, attaching the logic for inquiring a terminal user about which add-on user interface application among the add-on user interface applications is to be attached to the extensible elements in the set of extensible elements while attaching the add-on user interface applications to the extensible elements.

18. An article of manufacture tangibly embodying computer readable instructions which, when implemented, cause a computer to carry out the steps of a method according to claim 9.
